(19) United States
(12) Patent Application Publication
(10) Pub. No.: US 2005/0000339 A1
(43) Pub. Date: Jan. 6, 2005

(54) Sawing machine

(76) Inventor: Lee-Cheng Chang, Taichung (TW)

Correspondence Address: BIRCH STEWART KOLASCH & BIRCH, PO BOX 747, FALLS CHURCH, VA, 22040-0747, US

(21) Appl. No.: 10/610,869

(22) Filed: Jul. 2, 2003

(51) Int. Cl. B26D 1/18; B27B 3/28

(52) U.S. Cl. 83/477.2; 83/491

(57) ABSTRACT

A sawing machine includes a table, a driving device, a transmission and a saw. The table defines a slot. The driving device is attached to the table. The transmission is connected with the driving device. The saw is exposed through the slot for cutting. The saw is connected with the transmission so that the driving device drives the saw via the transmission.

### FIELD OF INVENTION

The present invention relates to a sawing machine and, more particularly, to connection of a buzz saw with a motor via a wheel-and-belt device.

### BACKGROUND OF INVENTION

Taiwanese Patent Publication No. 163685 discloses a sawing machine including an arm 10, a motor 20, a transmission and a saw 80. The motor 20 includes a mandrel 51. The transmission includes a shell 40 It attached to the arm 10. The shell 40 defines a first hole and a second hole communicated with the first hole. The mandrel 51 extends into the first hole of the shell 40. A wheel 50 is put in the second hole of the shell 40 and engaged with the mandrel 51. A shaft 60 is connected with the wheel 50. The saw 80 is mounted on the shaft 60. The teeth of the mandrel 51 strike the teeth of the wheel 50. The wheel 50 rattles on the shaft 60. Thus, the transmission makes a lot of noise in operation.

The present invention is therefore intended to obviate or at least alleviate the problems encountered in prior art.

### SUMMARY OF INVENTION

It is the primary objective of the present invention to provide a sawing machine for smooth and quiet operation.

According to the present invention, a sawing machine includes a table, a driving device, a transmission and a saw. The table defines a slot. The driving device is attached to the table. The transmission is connected with the driving device. The saw is exposed through the slot for cutting. The saw is connected with the transmission so that the driving device drives the saw via the transmission.

Other objects, advantages and novel features of the invention will become more apparent from the following detailed description in conjunction with the attached drawings.

### BRIEF DESCRIPTION OF DRAWINGS

The present invention will be described via detailed illustration of embodiments referring to the drawings.

FIG. 1 is a perspective view of a sawing machine according to the present invention.

FIG. 2 is a perspective view of a driving device, a transmission and a saw of the sawing machine shown in FIG. 1

FIG. 3 is an exploded view of the driving device, the transmission and the saw shown in FIG. 2.

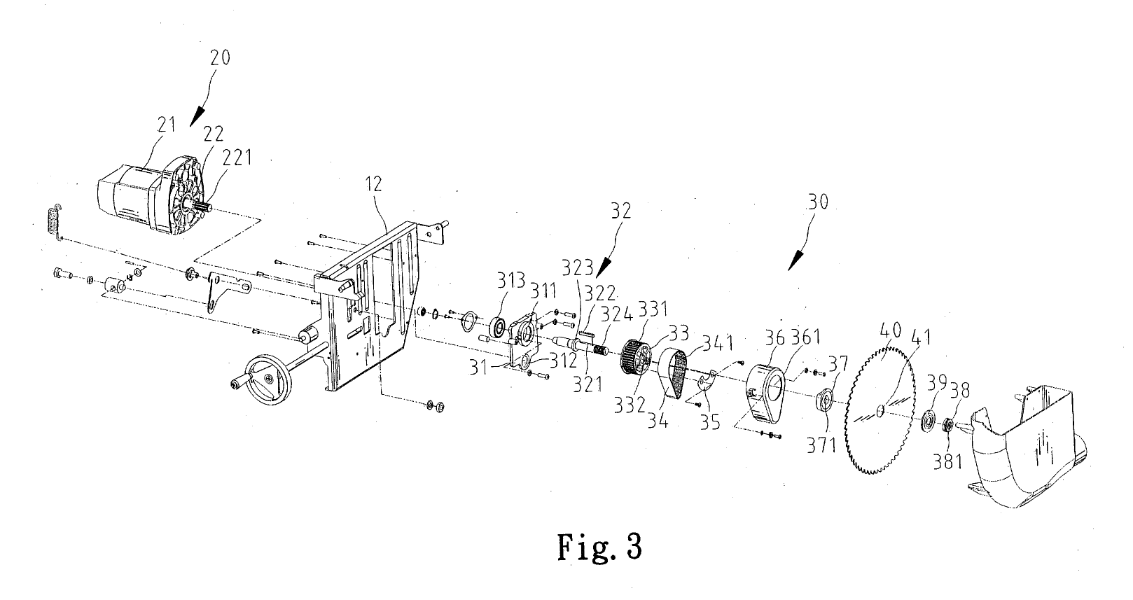

FIG. 4 is a front view of the driving device, the transmission and the saw shown in FIG. 2.

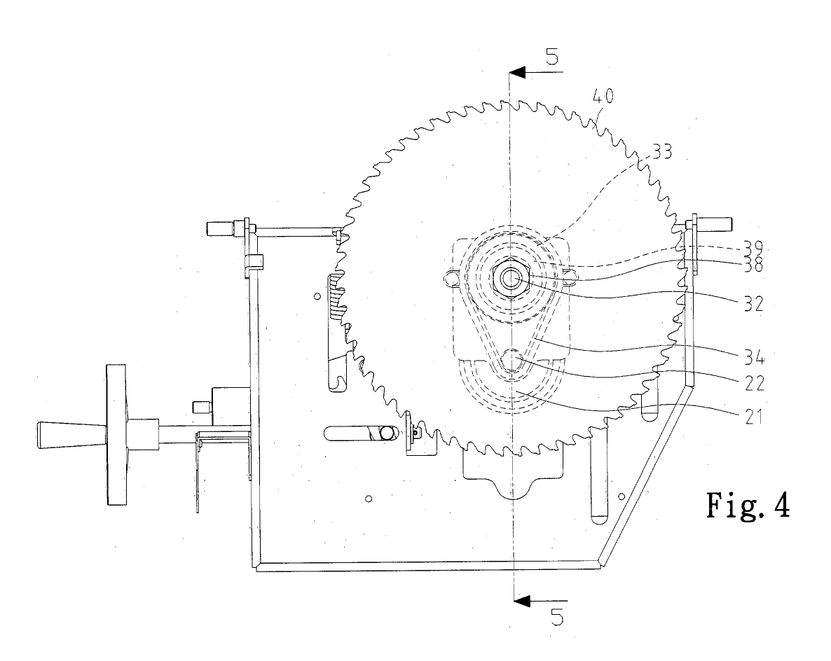

FIG. 5 is a cross-sectional view taken along a line 5-5 in FIG. 4.

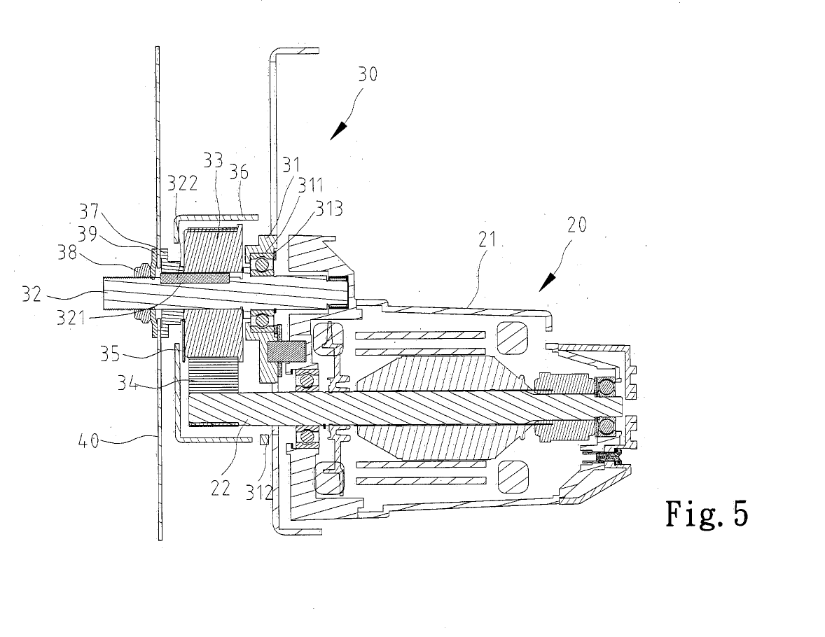

### DETAILED DESCRIPTION OF PREFERRED EMBODIMENT

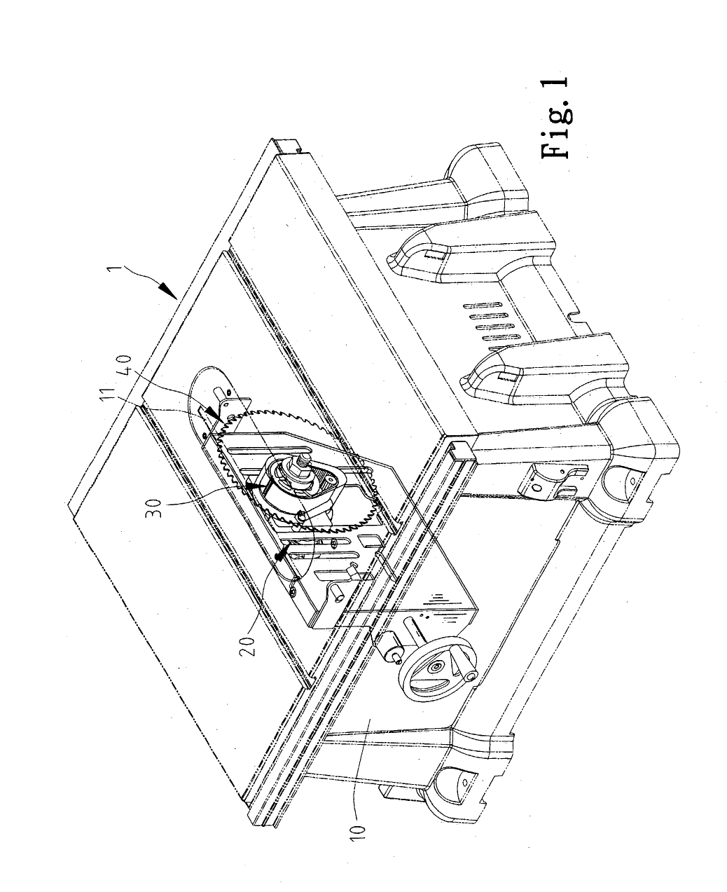

Referring to FIG. 1, a sawing machine 1 according to the preferred embodiment of the present invention is shown. The sawing machine 1 includes a table 10, a driving device 20, a transmission 30 and a saw 40. The table 10 defines a slot 11. The driving device 20 drives the saw 40 through the transmission 30. The saw 40 is a buzz saw exposed through the slot 11. The saw 40 includes a major portion put below the table 10 and a minor put above the table 10 for sawing.

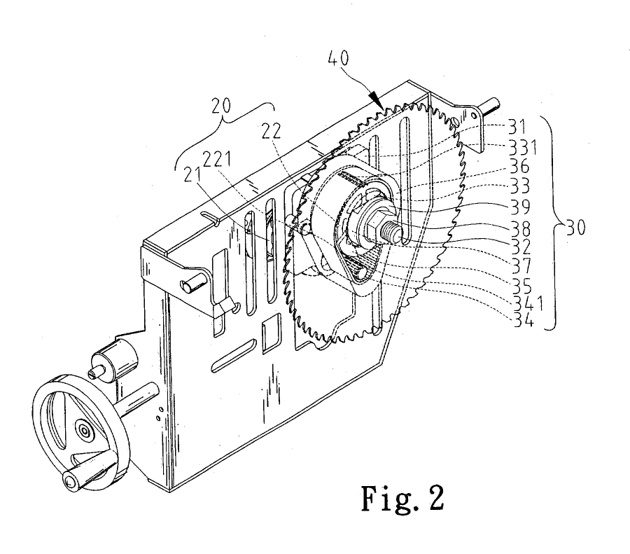

Referring to FIGS. 2˜5, the sawing machine 1 includes a plate 12 attached to the table 10.

The driving device 20 includes a motor 21. The motor 21 is located below the table 10 and attached to the plate 12. The motor 21 includes a mandrel 22. The mandrel 22 includes a toothed portion 221.

The transmission 30 includes a plate 31, a shaft 32, a wheel 33, a belt 34, a belt retainer 35, a shell 36, a first friction washer 37, a second friction washer 39 and a nut 38.

The plate 31 is attached to the plate 12. The plate 31 defines holes 311 and 312. The mandrel 22 extends through the hole 312. A bearing 313 is put in the hole 311.

The shaft 32 includes a first portion mounted on the bearing 313, a second portion, an annular ridge 323 formed between the first and second portions and a thread 324 formed on the second section. The second portion of the shaft 32 defines a groove 321 for receiving a key 322.

The wheel 33 is mounted on the shaft 32 against the annular ridge 323. The wheel 33 defines a groove 332 in an internal face for receiving the key 322. Thus, the wheel 33 is rotational together with the shaft 32. The wheel 33 includes a toothed external face.

The belt 34 is mounted on the mandrel 22 and the wheel 33. The belt 34 includes a toothed internal face 341 engaged with the toothed portion 221 and the toothed external face 331.

The belt retainer 35 is secured to the wheel 33 so as to retain the belt 34 on the wheel 33.

The shell 36 is attached to the plate 31 so as to conceal the mandrel 22, the wheel 33, the belt 34 and the belt retainer 35. The shell defines an aperture 361 through which the second portion of the shaft 32 extends.

The first friction washer 37 is mounted on the second section of the shaft 32 against the wheel 33. The first friction washer 37 defines a recess 371 for receiving the key 322. Thus, the first friction washer 37 is rotational together with the shaft 32. The saw 40 is mounted on the shaft 32. The saw 40 defines an aperture 41 through which the second the shaft 32 extends. The second friction washer 39 is mounted on the second portion of the shaft 32 against the saw 40. The nut 38 is mounted on the second portion of the shaft 32 against the second friction washer 39. The nut 38 includes a thread 381 formed on an internal face. The thread 381 is engaged with the thread 324 so as to clamp the saw 40 between the first friction washer 37 and the second friction washer 39.

The present invention has been described via detailed illustration of the preferred embodiment. Those skilled in the art can derive variations from the preferred embodiment without departing from the scope of the present invention. Therefore, the preferred embodiment shall not limit the scope of the present invention defined in the claims.

1. A sawing machine including:
a table defining a slot;
a driving device attached to the table;
a transmission connected with the driving device; and
a saw exposed through the slot for cutting, wherein the saw is connected with the transmission so that the driving device drives the saw via the transmission.

2. The sawing machine according to claim 1 wherein the driving device includes a motor with a mandrel, and the transmission includes a shaft and a belt mounted on the mandrel and the shaft.

3. The sawing machine according to claim 2 wherein the mandrel includes a toothed portion formed thereon, and the shaft includes a toothed portion formed thereon, and the belt includes a toothed face engaged with the toothed portion of the mandrel and the toothed portion of the shaft.

4. The sawing machine according to claim 3 wherein the toothed portion of the shaft is a toothed wheel attached to the shaft.

5. The sawing machine according to claim 4 wherein the shaft includes a groove defined therein, and the toothed wheel includes a groove defined in an internal face, and the transmission includes a key with a portion put in the groove of the shaft and another portion put in the groove of the toothed wheel.

6. The sawing machine according to claim 5 wherein the transmission includes a belt retainer attached to the toothed wheel for retaining the belt on the toothed wheel.

7. The sawing machine according to claim 4 wherein the shaft includes an annular ridge formed thereon for abutment against the toothed wheel.

8. The sawing machine according to claim 7 wherein the shaft includes a thread formed thereon, and the transmission includes a nut with a thread formed on an internal face for engagement with the thread of the shaft for pressing the saw against the toothed wheel.

9. The sawing machine according to claim 8 wherein the transmission includes a clamping device for clamping the saw between the toothed wheel and the nut.

10. The sawing machine according to claim 9 wherein the clamping device includes a first friction washer and a second friction washer.
